(19) United States
(12) Patent Application Publication
(10) Pub. No.: US 2019/0232554 A1
(43) Pub. Date: Aug. 1, 2019

(54) PROPYLENE BASED FILAMENT FOR 3D PRINTER

(71) Applicant: BASELL POLIOLEFINE ITALIA S.R.L., MILANO (IT)

(72) Inventors: ROBERTO DE PALO, FERRARA (IT); CLAUDIO CAVALIERI, FERRARA (IT)

(73) Assignee: BASELL POLIOLEFINE ITALIA S.R.L., MILANO (IT)

(21) Appl. No.: 16/340,958

(22) PCT Filed: Sep. 22, 2017
(86) PCT No.: PCT/EP2017/074124

§ 371 Date: Apr. 10, 2019

(30) Foreign Application Priority Data
Oct. 11, 2016 (EP) 16193232.2

(51) Int. Cl. B29C 64/118; C08L 23/16

(52) U.S. Cl. CPC B29C 64/118; C08L 23/16; B33Y 10/00; C08L 2203/12; C08L 2207/02

(57) ABSTRACT

A consumable filament for use in an extrusion-based additive manufacturing system made from or containing a heterophasic propylene ethylene copolymer having a xylene soluble content ranging from 15 wt % to 50 wt % and a melt flow rate MFR L (Melt Flow Rate according to ISO 1133, condition L, i.e. 230° C. and 2.16 kg load) ranging from 0.5 to 100 g/10 min.

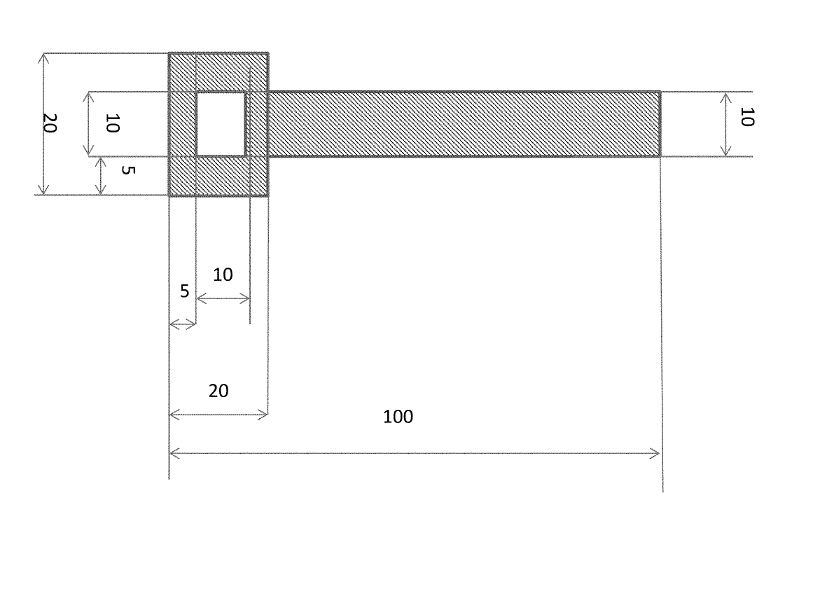

### FIELD OF THE INVENTION

In general, the present disclosure relates to the field of chemistry. More specifically, the present disclosure relates to polymer chemistry. In particular, the present disclosure relates to a filament made from or containing a heterophasic propylene ethylene copolymer to be used in an extrusion-based 3D printer.

### BACKGROUND OF THE INVENTION

An extrusion-based 3D printer is used to build a 3D model from a digital representation of the 3D model in a layer-by-layer manner by extruding a flowable modeling material. A filament of the modeling material is extruded through an extrusion tip carried by an extrusion head and deposited as a sequence of roads on a substrate in an x-y plane. The extruded modeling material fuses to previously-deposited modeling material and solidifies upon a drop in temperature. The position of the extrusion head relative to the substrate is then incremented along a z-axis (perpendicular to the x-y plane), and the process is then repeated to form a 3D model resembling the digital representation. Movement of the extrusion head with respect to the substrate is performed under computer control, in accordance with build data that represents the 3D model. The build data is obtained by slicing the digital representation of the 3D model into multiple horizontally sliced layers. For each sliced layer, the host computer generates a build path for depositing roads of modeling material to form the 3D model.

In the printing process, changing the material of the filament changes the final mechanical and aesthetic properties of the finished object. In some instances, filament of polylactic acid (PLA) or acrylonitrile, butadiene, styrene (ABS) polymer or polyamides are used.

It is believed that maintaining a constant diameter (in some instances, 1.75 mm or 3 mm) of the filament facilitates finely tuning the amount of material in the printed object.

### SUMMARY OF THE INVENTION

In a general embodiment, a process for preparing an extrusion-based article of manufacture in an extrusion-based additive manufacturing system including extruding a consumable filament is provided. In a general embodiment, the consumable filament is made from or contains a heterophasic propylene ethylene copolymer having a xylene soluble content ranging from 15 wt % to 50 wt % and a melt flow rate MFR L (Melt Flow Rate according to ISO 1133, condition L, 230° C. and 2.16 kg load) ranging from 0.5 to 100 g/10 min.

### BRIEF DESCRIPTION OF THE DRAWINGS

The FIGURE shows the front view of a 3D printed article. The measurements are given in mm. When printed, the article was 5 mm thick.

### DETAILED DESCRIPTION OF THE INVENTION

In some embodiments, a consumable filament for use in an extrusion-based additive manufacturing system is provided. The consumable filament is made from or contains a heterophasic propylene ethylene copolymer having a xylene soluble content ranging from 15 wt % to 50 wt %; alternatively from 20 wt % to 40 wt % alternatively from 22 wt % to 35 wt % and a melt flow rate MFR L (Melt Flow Rate according to ISO 1133, condition L, 230° C. and 2.16 kg load) ranging from 0.5 to 100 g/10 min; alternatively from 2.0 to 50.0 g/10 min; alternatively from 5.0 to 20.0 g/10 min.

As used herein, the term “heterophasic copolymer” indicates that an elastomeric propylene ethylene copolymer is dispersed in the matrix of a propylene homopolymer or copolymer. In other words, the elastomeric propylene ethylene copolymer forms inclusions in the matrix. The matrix contains dispersed inclusions being not part of the matrix, and the inclusions contain the elastomeric propylene copolymer. As used herein and in some embodiments, the term “inclusion” indicates that the matrix and the inclusion form different phases within the heterophasic system. The inclusions are visible by high resolution microscopy, like electron microscopy or scanning force microscopy.

In some embodiments, the heterophasic propylene ethylene copolymer has an ethylene content ranging from 5 wt % and 30 wt %; alternatively from 8 wt % to 25 wt %; alternatively from 10 wt % and 20 wt %.

In some embodiments, the matrix of the heterophasic propylene ethylene content is a propylene homopolymer or a propylene ethylene copolymer having an ethylene content up to 10 wt %; alternatively up to 5 wt %. In some embodiments, the matrix is a propylene homopolymer.

In some embodiments, the elastomeric phase is a propylene ethylene copolymer having an ethylene content ranging from 12 wt % to 80 wt %; alternatively from 30 wt % to 70 wt %.

In some embodiments, the intrinsic viscosity of the fraction soluble in xylene at 25° C. ranges from 2.0 to 6.0 dl/g; alternatively from 2.5 to 5.0 dl/g; alternatively from 3.1 dl/g to 4.5 dl/g

As used herein, the term “copolymer” refers to a polymer formed by only two monomers, propylene and ethylene.

As used herein, the term “xylene soluble” or “xylene soluble fraction” refers to the fraction soluble in xylene at 25° C. measured according to the procedure described in the Examples.

In some embodiments, the heterophasic propylene ethylene copolymer is extruded in a filament having a constant diameter. In some embodiments, the diameter of the filament is 1.75 mm or 3 mm. In some embodiments, other diameters are used. In some embodiments, the variation from the nominal diameter is +/−0.05 mm, alternatively +/−0.03 mm.

In some embodiments, the propylene ethylene copolymer are commercially available as EP3080 or EP3307 from LyondellBasell,

In some embodiments, the filament object additionally contains additives. In some embodiments, the additives are selected from the group consisting of antioxidants, slipping agents, process stabilizers, antiacid and nucleants.

In some embodiments, the filament contains fillers. In some embodiments, the fillers are selected from the group consisting of talc, calcium carbonate, wollastonite, glass fibers, glass spheres and carbon derived grades.

In some embodiments, the filament contains wood powder, metallic powder, marble powder and other materials used for obtaining 3D object having aesthetic appearances or mechanical properties.

The following examples are given to illustrate and not to limit the present invention.

### Examples

The data of the propylene polymer materials were obtained according to the following methods:

Xylene-Soluble Fraction at 25° C.

The Xylene Soluble fraction was measured according to ISO 16152, 2005, but with the following deviations (the ISO 16152 specification provided within parentheses)

The solution volume was 250 ml (200 ml)

During the precipitation stage at 25° C. for 30 min, the solution, for the final 10 minutes, was kept under agitation by a magnetic stirrer (30 min, without any stirring at all)

The final drying step was done under vacuum at 70° C. (100° C.)

The content of the xylene-soluble fraction was expressed as a percentage of the original 2.5 grams and then, by difference (complementary to 100), the xylene insoluble %

Ethylene (C2) Content

¹³C NMR of Propylene/Ethylene Copolymers

¹³C NMR spectra were acquired on a Bruker AV-600 spectrometer equipped with cryoprobe, operating at 160.91 MHz in the Fourier transform mode at 120° C.

The peak of the S_{ββ} carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as an internal reference at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD to remove 1H-13C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules, 1982, 15, 1150) using the following equations:

PPP=100T_{ββ}/S PPE=100T_{βδ}/S EPE=100T_{δδ}/S

PEP=100S_{ββ}/S PEE=100S_{βδ}/S EEE=100(0.25S_{γδ}+0.5S_{δδ})/S

S=T_{ββ}+T_{βδ}+T_{δδ}+S_{ββ}+S_{βδ}+0.25S_{γδ}+0.5S_{δδ}

The molar percentage of ethylene content was evaluated using the following equation:

E% mol=100*[PEP+PEE+EEE]

The weight percentage of ethylene content was evaluated using the following equation:

$$E \% wt . = \frac{100 ⋆ E \% mol ⋆ {MW}_{E}}{E \% mol ⋆ {MW}_{E} + P \% mol ⋆ {MW}_{P}}$$

where P % mol is the molar percentage of propylene content while MW_{E} and MW_{P} are the molecular weights of ethylene and propylene, respectively.

The product of reactivity ratio r₁r₂ was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of Propylene sequences was calculated as mm content from the ratio of the PPP mmT_{ββ} (28.90-29.65 ppm) and the whole T_{ββ} (29.80-28.37 ppm)

Melt Flow Rate (MFR)

The melt flow rate MFR of the polymer was determined according to ISO 1133 (230° C., 2.16 Kg).

The following polymers have been used

PP1

Propylene homopolymer having an MFR 6.5 and a fraction soluble in xylene at 25° C. of <4 wt %

PP2

Commercial filament of diameter 1.75 mm sold under the tradename PP REPRAP BLACK FILAMENT German RepRap PP Filament 600 g, a random propylene ethylene copolymer having an ethylene content of 3 wt %, a MFR of 2 dl/10 min, and a fraction soluble in xylene at 25° C. of 6.2 wt %.

PP3

Heterophasic propylene ethylene copolymer sold under the tradename HIFAX EP3080 having an ethylene content of 18 wt %, xylene soluble content of 32.0 wt %, a MFR of 7.5 g/10 min. and an intrinsic viscosity of xylene soluble fraction IV of 3.5 dl/g.

Polymers PP1 and PP3 were extruded to form a filament having 1.75 mm of diameter. To extrude PP1, 10 wt % of talc was added.

Print Test

The printer was a 3D Rostock delta printer. The printer conditions were the following:

| | | |
|---|---|---|
| Filament diameter | mm | 1.75 ± 0.03 |
| Nozzle diameter | mm | 0.4 |
| Temperature first layer | ° C. | 245 |
| Temperature other layers | ° C. | 245 |
| | | 1 |
| Layer high | mm | 0.2 |
| Temperature plate | ° C. | 100 |
| Plate material. | | polybutene |
| | | sheet |
| | | PB0300M |
| Infill | | 100% |
| printer speed | mm/min | 3600 |
| Speed first layer | | 60% |
| Speed other layers | | 100% |
| Speed infill | mm/min | 4.000 |

The sample to be printed was depicted in the FIGURE. For each filament, five (5) printer tests were carried out. The print was stopped when one side of the object was detached from the plane. The results are reported in Table 1.

TABLE 1

| | height before detach |
|---|---|
| | (Z) (mm) (average |
| material | measure) |
| PP1* | 0.8 |
| PP2* | 1.2 |
| PP3 | full (5 mm) |

*comparative

What is claimed is:

1. A process comprising the step of:
extruding a consumable filament comprising
a heterophasic propylene ethylene copolymer having a xylene soluble content measured according to ISO 16152, 2005 ranging from 15 wt % to 50 wt %, a melt flow rate MFR L (Melt Flow Rate according to ISO 1133, condition L, 230° C. and 2.16 kg load) ranging from 0.5 to 100 g/10 min, wherein the step of extruding the consumable filament takes place in an extrusion-based additive manufacturing system.

2. The process according to claim 1, wherein, in the heterophasic propylene ethylene copolymer, the xylene soluble content ranges from 20 wt % to 40 wt %.

3. The process according to claim 1, wherein, in the heterophasic propylene ethylene copolymer, the MFR L (Melt Flow Rate according to ISO 1133, condition L, 230° C. and 2.16 kg load) ranges from 2.0 to 50.0 g/10 min.

4. The process according to claim 1, wherein the heterophasic propylene ethylene copolymer has an ethylene content ranging from 5 wt % and 30 wt %.

5. The process according to claim 1, wherein, in the heterophasic propylene ethylene copolymer, the matrix is a propylene homopolymer or a propylene ethylene copolymer having an ethylene content up to 10 wt %.

6. The process according to claim 1, wherein, in the heterophasic propylene ethylene copolymer, the matrix is a propylene homopolymer.

7. The process according to claim 1, wherein the heterophasic propylene ethylene copolymer has a fraction soluble in xylene at 25° C. and the intrinsic viscosity of the fraction soluble in xylene at 25° C. ranges from 2.0 to 6.0 dl/g.

8. The process according to claim 1, wherein the heterophasic propylene ethylene copolymer has a fraction soluble in xylene at 25° C. and the intrinsic viscosity of the fraction soluble in xylene at 25° C. ranges from 2.5 to 5.0 dl/g.

9. A consumable filament of claim 1, wherein the filament has a diameter of 1.75 mm or 3 mm+/−0.05 mm.

10. The process of claim 1 comprising the step of forming a 3D printed article with the filament.
